(19) United States
(12) Patent Application Publication
(10) Pub. No.: US 2026/0120591 A1
(43) Pub. Date: Apr. 30, 2026

(54) COMPACT FLIGHT SIMULATION SYSTEM

(71) Applicant: Loft Dynamics AG., Dübendorf (CH)

(72) Inventors: Aldo ZUBERBÜHLER, Dübendorf (CH); Christian MARTY, Dübendorf (CH); Philipp MIERMEISTER, Dübendorf (CH); Michael KRYENBÜHL, Dübendorf (CH); Roman ITEN, Dübendorf (CH); Stefan Markus JUCKER, Dübendorf (CH); Tamara WEISSENBACH, Dübendorf (CH); Simon LOCHER, Dübendorf (CH)

(21) Appl. No.: 19/374,810

(22) Filed: Oct. 30, 2025

Related U.S. Application Data
(60) Provisional application No. 63/714,744, filed on Oct. 31, 2024.

(51) Int. Cl. G09B 9/12

(52) U.S. Cl. CPC G09B 9/12

(57) ABSTRACT

A compact flight simulation system uses a flight simulation platform having a base and a simulator cabin positioned above the base. A plurality of actuators is connected between the base and a side of the simulator cabin in a location on the side of the simulator cabin substantially corresponding to a center of mass of the simulator cabin. The simulation system has a simulation computer receiving flight control signals from the simulator cabin and outputting a simulated flight state to an actuation controller, wherein the actuation controller controls movement of the plurality of actuators. The compact flight simulation system provides a motion platform design with maximal range within a constrained space, a motion cueing optimized motion envelope, and dynamic characteristics.

### CROSS REFERENCE TO RELATED APPLICATIONS

This application claims benefit of U.S. Provisional Application Ser. No. 63/714,744 entitled, “Compact Flight Simulation System” filed Oct. 31, 2024, the entire disclosure of which is incorporated herein by reference.

### FIELD OF THE DISCLOSURE

The present disclosure relates to compact flight simulation systems. The disclosure has particular utility in aircraft flight simulations in a compact area which uses a simulation motion platform design with maximal range within a constrained space, a motion cueing optimized motion envelope, and dynamic characteristics, and will be described in connection with such utility, although other utilities are contemplated.

### BACKGROUND AND SUMMARY

This section provides background information related to the present disclosure which is not necessarily prior art. This section provides a general summary of the disclosure and is not a comprehensive disclosure of its full scope or all its features.

Flight simulation is used to artificially generate aircraft flight and an environment in which the aircraft flies, for pilot training, design, or other purposes. Flight simulators typically virtually recreate situations of aircraft flight, including how aircraft react to applications of flight controls, the effects of other aircraft systems, and how the aircraft reacts to external factors such as air density, turbulence, wind shear, clouds, precipitation, etc. Flight simulation is used for a variety of reasons, including flight training for pilots, the design and development of the aircraft itself, and research into aircraft characteristics and control handling qualities. Some simulations are based on previously recorded flights and incorporate actual components of aircraft hardware or software or replicas thereof, which stimulate cues of actual flight to support intended training purposes.

There are various types of flight simulators which offer varying benefits and levels of simulation. Flight simulators with the highest level of fidelity with regards to the simulated environment, systems, flight dynamics, pilot cues and, other relevant aspects are referred to as Full Flight Simulators (FFS). These FFSs are typically used by training organizations or aviation operators, and they are essential for pilot training, checking, and testing purposes. FFSs use a motion platform which can produce motion cues in six degrees of freedom (6-DOF), such that FFS can provide a simulation with cueing to the pilot inside the cabin to support training. Most current FFSs sit on a motion system based on a Stewart platform, which is a hexapodal structure of actuators.

FIGS. 1A-1B are illustrations of a conventional FFS 10 using a Stewart platform as a motion platform 20, in accordance with the prior art. As shown, the motion platform 20 may include a base 22, actuators 24 extending from the base 22 and connected to a bottom of the cabin 26. The actuators 24 may be connected directly to the bottom of the cabin 26, or to a platform 28 which is positioned below the cabin 26, as shown. A Stewart platform has six prismatic actuators formed from hydraulic jacks, electric linear actuators, or other types of actuator devices. FIG. 1A depicts the FFS 10 in a starting or rest position, where the actuators 24 are generally retracted, yet the cabin 26 is positioned relatively high above the floor. As a result, such an FFS 10 requires gantries or ladders for pilot access to the cabin 26. This elevated starting position of the cabin 26 makes it harder to exit the FFS 10 in the event of an emergency.

When the FFS 10 is in use, the actuators 24 of the motion platform 20 move the cabin 26 to even further elevated positions, as shown in FIG. 1B, where the actuators 24 are extended and the cabin 26 is positioned in an elevated position above the floor. Accordingly, the building housing the FFS 10 needs to be tall in order to allow proper clearance between the cabin 26 and any overhead structures. For a typical FFS 10 used conventionally, the building may need to be sized with at least 8 meters of lateral space and 12 meters of overhead clearance. These spatial constraints often mean buildings housing FFSs 10 have custom designs, which adds to the cost of installation.

Additionally, current FFSs 10 must physically execute large translational motions when simulating rotational motion of the air because the pilot's position is vertically displaced from the center of the motion platform during this rotational movement. The center of the motion platform may be characterized as the location around which the system has the largest rotational workspace without requiring translational motion of the system to maintain the rotational center at or near the pilot's position. These large translational motions can decrease the responsiveness of the system. Such movements can also cause unintended motion cueing. For example, a fast rotational movement in a conventional FFS 10 can cause the pilot to sense inaccurate forces due to their position above the motion platform, even when not intended.

To improve over these limitations of conventional simulation systems, the present disclosure is directed to an FFS based on a Stewart platform, with joints mounted to the sides of the simulator cabin and actuator design ratios from an accompanying design optimization process that can place the simulator cabin close to the ground, with pilot seating close to center of the motion platform. Locating the cabin closer to the ground enables the motion system to be located within a much smaller and shorter building for any given cabin size while still moving the cabin enough to provide accurate motion cues for pilot training. This means the simulator can be installed in conventional industrial buildings, which simplifies installation and reduces project complexity and costs to a small fraction of what is currently required for conventional FFSs. Also, the users can board the system from ground level, which is simpler and improves safety in case of emergency.

Embodiments of the present disclosure provide a flight simulation platform. Briefly described, in architecture, one embodiment, among others, can be implemented as follows. A flight simulation platform has a base and a simulator cabin positioned above the base. A plurality of actuators is connected between the base and a side of the simulator cabin, wherein the plurality of actuators are connected to the side of the simulator cabin in a location substantially corresponding to a center of mass of the simulator cabin.

In one aspect, the plurality of actuators have retracted and extended states, wherein in a retracted state, the simulator cabin is positioned proximate to a floor on which the base is positioned.

In another aspect, the location substantially corresponding to the center of mass of the simulator cabin is aligned with a horizontal line positioned through a vertical midpoint of the simulator cabin.

In yet another aspect, the location substantially corresponding to the center of mass of the simulator cabin is aligned with a horizontal line positioned below a vertical midpoint of the simulator cabin.

In another aspect, the location where the plurality of actuators are connected to the side of the simulator cabin is adjustable.

In still another aspect, the plurality of actuators are connected to at least one of the side of the simulator cabin or the base with at least one multiple degree of freedom (DOF) joint.

In this aspect, the at least one multiple DOF joint translates and rotates the simulator cabin upon actuator motion.

In another aspect, a center of motion of the simulator cabin is positioned substantially at a vertical midpoint and a horizontal midpoint of the simulator cabin. In another embodiment, the present disclosure can be viewed as providing a flight simulation system. Briefly described, in architecture, one embodiment of the system, among others, can be implemented as follows. A flight simulation platform has a simulator cabin and a plurality of actuators is connected to a side of the simulator cabin, wherein the plurality of actuators are connected to the side of the simulator cabin in a location substantially corresponding to a center of mass of the simulator cabin. A simulation computer receives flight control signals from the simulator cabin and outputs a simulated flight state to an actuation controller. The actuation controller controls movement of the plurality of actuators.

In one aspect, the plurality of actuators have retracted and extended states, wherein in a retracted state, the simulator cabin is positioned proximate to a floor on which the base is positioned.

In another aspect, the location substantially corresponding to the center of mass of the simulator cabin is aligned with a horizontal line positioned through or below a vertical midpoint of the simulator cabin.

In yet another aspect, the location where the plurality of actuators are connected to the side of the simulator cabin is adjustable.

In still another aspect, the plurality of actuators are connected to at least one of the side of the simulator cabin or the base with at least one multiple degree of freedom (DOF) joint.

In this aspect, the at least one multiple DOF joint translates and rotates the simulator cabin upon actuator motion.

In another aspect, the flight simulator platform is operatable in a space not exceeding 6 meters in length and width, respectively, and 4.2 meters in height.

In another aspect, the flight simulator platform is operatable in a space having height dimension not exceeding length and width dimensions.

In still another aspect, the actuation controller controls movement of the plurality of actuators to simulate rotational motion from the simulated flight state by sending commands that only rotate the simulator cabin.

The present disclosure can also be viewed as providing a method of controlling a flight simulation system. In this regard, one embodiment of such a method, among others, can be broadly summarized by the following steps: providing a flight simulation platform having a simulator cabin and a plurality of actuators connected to a side of the simulator cabin, wherein the plurality of actuators are connected to the side of the simulator cabin in a location substantially corresponding to a center of mass of the simulator cabin. Receiving, at a simulation computer, flight control signals from the simulator cabin. Outputting a simulated flight state to an actuation controller, wherein the actuation controller controls movement of the plurality of actuators.

In one aspect, movement of the plurality of actuators moves the simulator cabin around a center of motion of the simulator cabin, wherein the center of motion is positioned substantially at a vertical midpoint and a horizontal midpoint of the simulator cabin.

In another aspect, the method further comprises: simulating aircraft flight dynamics to get a state vector for a pilot at the pilot's position; in a nonlinear optimizer, optimizing motions of the simulator cabin to minimize perception error, minimize violation of motion system hardware constraints, and minimize violation of motions system drive constraints; translating optimized motions into direct commands for the plurality of actuators; detecting actual motions of the simulator cabin; and updating the nonlinear optimizer on a state of the simulator cabin.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Further features and advantages of the disclosure will be seen in the following detailed description, taken in conjunction with the accompanying drawings. The drawings described herein are for illustrative purposes only of selected embodiments and not all possible implementations and are not intended to limit the scope of the present disclosure.

In the drawings:

FIGS. 1A-1B are illustrations of a conventional FFS using a Stewart platform, in accordance with the prior art;

FIGS. 2A-2B are illustrations of a flight simulation platform, in accordance with the present disclosure;

FIG. 3 is a diagrammatic illustration of a flight simulation system, in accordance with the present disclosure;

FIG. 4 is a diagrammatic illustration of the dimensions and ratios of aspects of a flight simulation platform, in accordance with an embodiment of the present disclosure;

FIG. 5 is a diagrammatic illustration of the dimensions and ratios of aspects of a flight simulation platform, in accordance with an embodiment of the present disclosure; and

FIG. 6 is a diagrammatic illustration of a simulation and control loop used in a flight simulation system, in accordance with the present disclosure.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, components, and/or groups, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers, and/or sections should not be limited by these terms. These terms may be only used to distinguish one element, component, region, layer or section from another element, component, region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present disclosure is directed to a compact flight simulation platform and flight simulation system which uses an FFS based on a Stewart platform. The FFS uses a motion platform with six degrees of freedom (DOF) with maximal range within a constrained space and motion cueing optimized motion envelope and dynamic characteristics. The motion platform has joints mounted to the sides of the simulator cabin and actuator design ratios from an accompanying design optimization process that can place the simulator cabin close to the ground, with pilot seating close to center of the motion platform. The center of the motion platform may be characterized as the location around which the system has the largest rotational workspace without requiring translational motion of the system. In one example, the center of the motion of the platform may be substantially aligned at a horizontal midpoint and vertical midpoint of the cabin. Conventional FFSs have a center of motion significantly below the pilot's position, and require translational motion to rotate around a point at or near the pilot's position. Locating the cabin closer to the ground enables the motion system to be located within a much smaller and shorter building for any given cabin size while still moving the cabin enough to provide accurate motion cues for pilot training. This means the simulator can be installed in conventional industrial buildings, which simplifies installation and reduces project complexity and costs to a small fraction of what is currently required for conventional FFSs. Also, the users can board the system from ground level, which is simpler and improves safety in case of emergency.

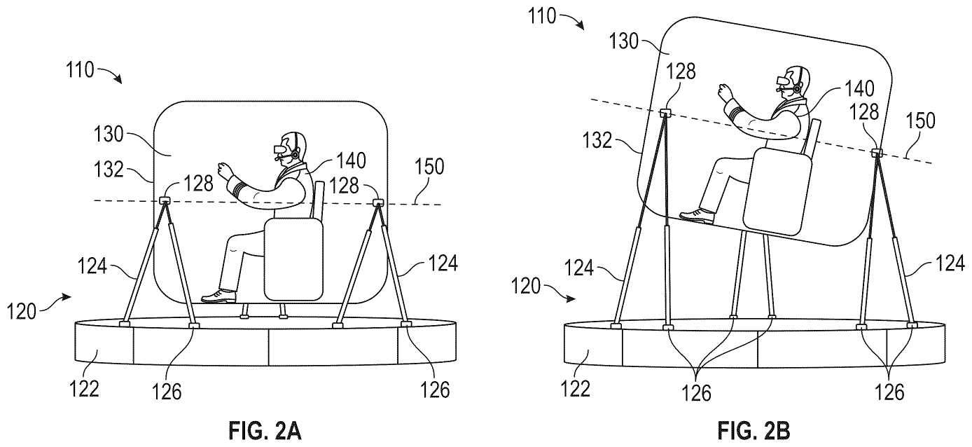

FIGS. 2A-2B are illustrations of a flight simulation platform 110, in accordance with the present disclosure. The flight simulation platform 110 may be an FFS which includes a motion platform 120 based on a Stewart platform. The motion platform 120 includes a base 122 and a plurality of actuators 124 connected to base 122. A simulator cabin 130 is positioned above base 122. Actuators 124 are connected between base 122 and a side 132 of the simulator cabin 130, and connected the simulator cabin 130 along the side 132 thereof. This may include actuators 124 being mounted to an external surface of the cabin 130 sidewall, or to another structure which is positioned along the sidewall of the cabin 130, such as an exterior frame.

The actuators 124 may be connected to a location on the side 132 of the simulator cabin 130 which substantially corresponds to a center of mass of the simulator cabin 130. As shown in FIGS. 2A-2B, the location of mounting of actuators 124 to cabin 130 may be substantially aligned with a horizontal line 150 of the cabin 130, which may align with the center of mass. Depending on the specific construction of the cabin 130, the horizonal line 150 may be positioned through a vertical midpoint of the cabin 130, or through another vertical point of the cabin 130 above or below the midpoint. For instance, a cabin 130 with an offset weight towards the bottom may be connected to the actuators 124 in a location below the vertical midpoint thereof.

The location of actuator 124 connection to the cabin 130 may also compensate for the actual or estimated center of mass of the cabin 130 with an occupant therein. In some examples, the position of connection between actuators 124 to the cabin 130 may be adjustable to account for changes in the center of mass due to fluctuations of mass in the cabin 130 between simulation sessions. For instance, it may be possible to adjust the connection point relative to a center of mass for simulations based on the number of occupants, the weight of occupants, the weight of simulation equipment used, or other parameters. These adjustments may also help improve the motion envelope of the simulator by altering geometric constraints in response to changes in the cabin 130 such as collisions between actuators and bounding box violations. This adjustability may include automatic or dynamic adjustments, such as those perceived from the platform 110 and made automatically, or manual adjustments which involve user input on the ideal connection point.

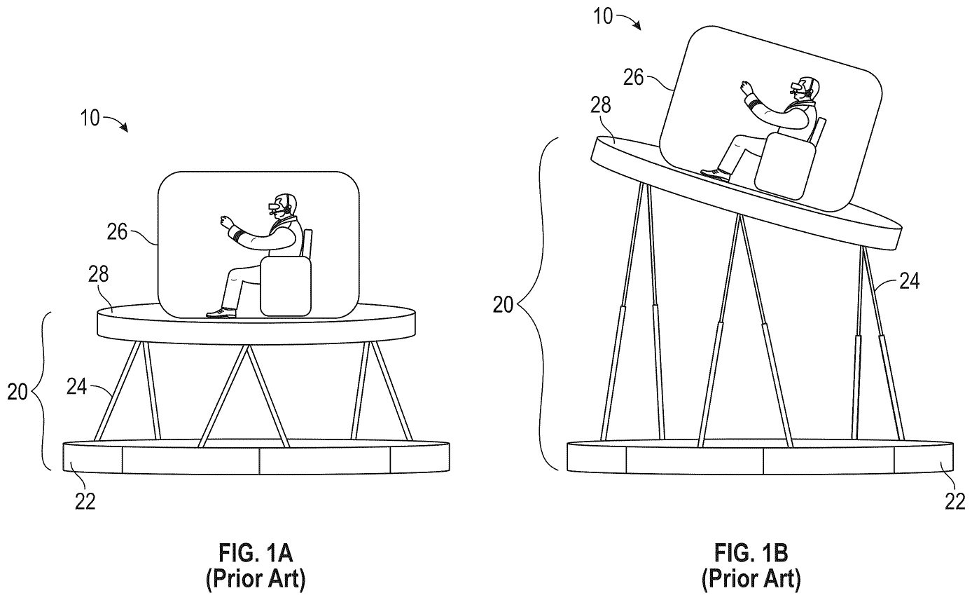

The platform 110 is in a starting or rest position in FIG. 2A, where actuators 124 are in a retracted state, which may include a fully or partially retracted state. FIG. 2B depicts the platform 110 in an elevated, in-use position, where actuators 124 are in an extended state, which may be a fully or partially extended state. Due to the connection point of actuators 124 along the side 132 of the cabin 130, the starting or rest position of the cabin 130, with actuators 124 retracted, is substantially closer to the floor than in conventional FFSs, such as shown in FIG. 1A. This closer position to the floor may be characterized as the cabin 130 being proximate to the floor, and this lower starting location improves efficiency of use since the user can gain entry or exit to the cabin 130 without a gantry or ladder. In the event of an emergency, the user can gain quick exit from the cabin 130 without incurring the time to have a gantry or ladder moved into position, thus improving the safety of the simulator.

Additionally, when the actuators 124 are in an extended state, and the platform 110 is in use, as shown in FIG. 2B, the cabin 130 height above the floor or ground is substantially lower than that of conventional systems, as shown in FIG. 1B. This lower height offers many practical advantages over conventional FFSs. A lower elevation of the cabin 130 means that the platform 110 can operate in more constrained spaces than conventional FFSs, such that the platform 110 can be installed in conventional industrial buildings, and without limiting the size of the aircraft cockpit simulated. The cabin 130 can still include cabins large enough for full-size aircraft cockpits installed in buildings that were not initially designed to house FFSs (e.g., standard commercial office buildings whose height per story is typically between 12 to 14 feet), as compared to the new, custom-built buildings often required for conventional FFSs. This simplifies installation and reduces project complexity and costs to a small fraction of what is currently required, which is a key factor to enable a large scale fleet of highest fidelity flight simulators. As a point of comparison, the platform 110 may be operatable in a constrained space of approximately 6 meters in length and width, respectively, and 4.2 meters in height, while conventional FFSs require 8 meters in length and width, respectively, and 12 meters of height clearance.

The actuators 124 may be mounted through an actuator mounting to multiple DOF joints 126 connected to a simulator mounting base 122 that sits on the ground and holds the simulator cabin 130 up. In some cases, the base 122 may be integrated into the ground or floor. The actuators 124 may be additionally connected to multiple DOF joints 128 mounted on the simulator cabin 130, and actuator motion pushes these multiple DOF joints 128 to physically translate and rotate the simulator cabin 130. The multiple DOF joints 128 on the cabin 130 may be mounted towards the middle of the cabin 130 in the height direction, so as to put the center of mass for the cabin 130 close to the location where the pilot 140 is positioned in the cabin. In one embodiment, the multiple DOF joints 128 for the cabin 130 and DOF joints 126 for the base 122, respectively, are mounted in a circular shape. In another embodiment, the multiple DOF joints 126, 128 have two degrees of freedom, which in yet another embodiment, the multiple DOF joints 126, 128 have three degrees of freedom.

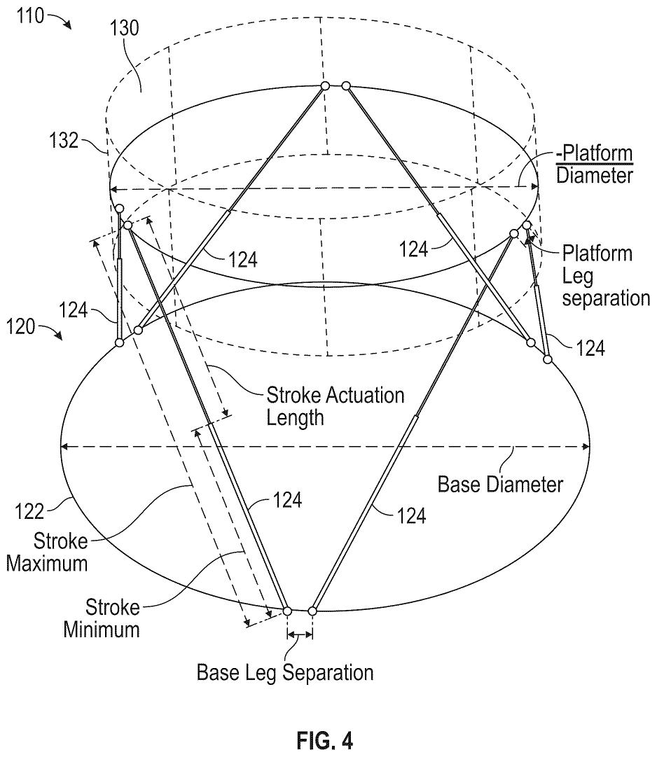

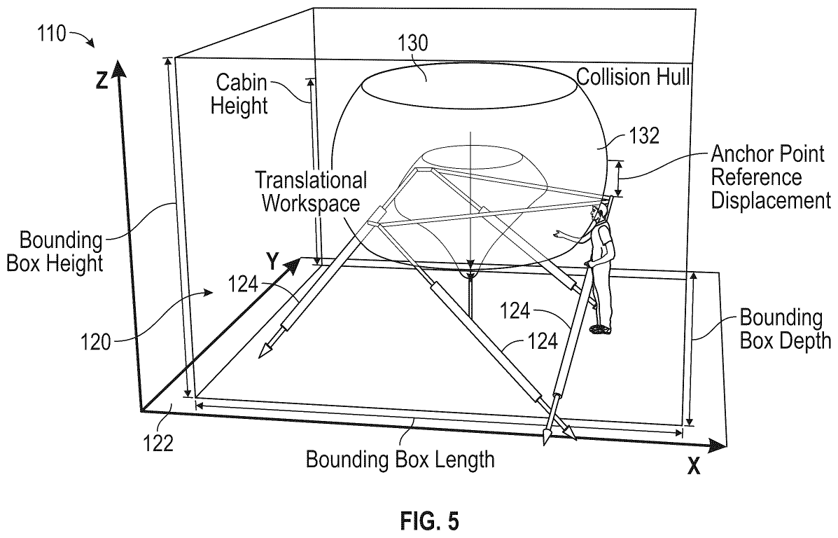

The number of actuators 124 may be equal to both the number of multiple DOF joints 126, 128 on the simulator mounting base 122 and on the simulator cabin 130, with the actuators 124 and multiple DOF joints 126, 128 oriented in a hexapod design. The hexapod design is depicted in FIGS. 2A-2B, and discussed in greater detail relative to FIGS. 4-5. In one embodiment, the number of actuators 124 is six. In one embodiment, the actuators 124 are hydraulicly powered, but they may also be electrically powered, or powered with another medium.

The positioning of the actuators 124 connected to the side 132 of the cabin 130 also offers benefits in motion to the cabin 130. The platform 110 can achieve actuator design length and force ratios that support a cabin of weight of 1500 to 2000 kg at a minimum height of less than 0.5 meters above the ground and have a bounding box with height dimensions less than length and depth dimensions, which conventional FFSs cannot achieve. Moreover, existing or conventional simulator platforms do not provide a design optimization process with minimum cabin position constraints to the ground. These improved design ratios allow sufficient motion range to provide motion cues for pilot training and comply with FFS certification specifications. The platform 110 is capable of moving the cabin 130 to meet the highest fidelity pilot cueing requirements (FFS motion range). It also offers improved cueing characteristics due to the improved motion envelope, motion workspace, and dynamics with respect to pilot's position.

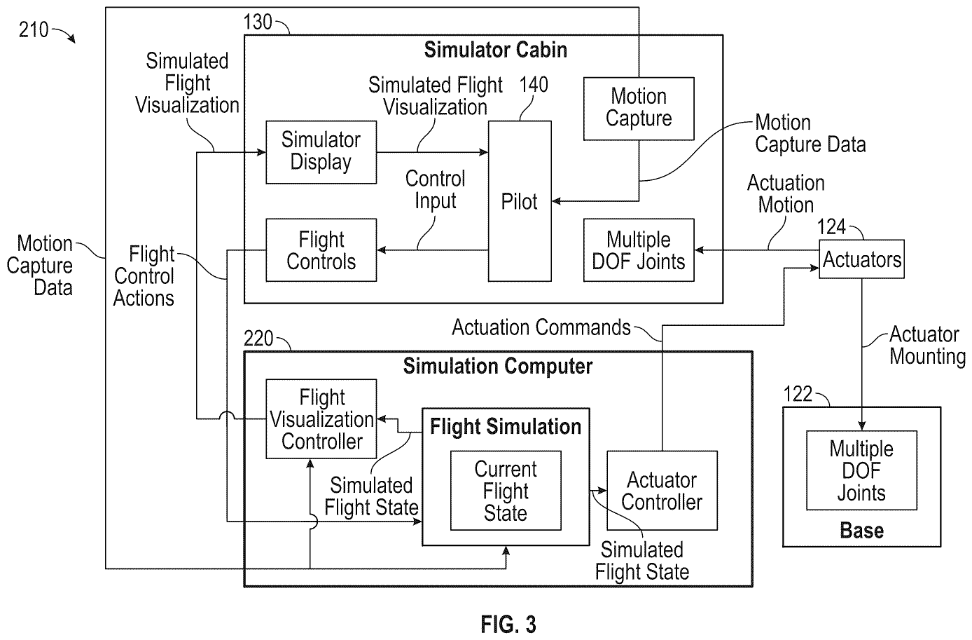

The platform 110 of FIGS. 2A-2B may be a component of a flight simulation system 210, as shown in FIG. 3. With reference to FIGS. 2A-3, a pilot 140 may sit in the simulator cabin 130, and view a simulated flight visualization from a simulator display within the cabin. This simulator display may include any type of display, such as a Virtual Reality (VR) headset, a screen in the cabin 130 displaying simulated flight visualizations, or another display device. During the simulation, the pilot 140 gives control inputs to the flight controls in the simulator cabin 130. The flight controls are designed to be similar to the flight controls of a real aircraft. The flight controls pass pilot control inputs as flight control actions to a flight simulation running on a simulation computer 220. In one embodiment the simulation computer 220 is separate from the simulator cabin 130 sitting on the ground, while in another embodiment the simulation computer 220 is mounted to the simulator cabin 130.

A motion capture system additionally collects motion capture data of the pilot's body pose and sends this motion capture data to the flight simulation as well. The flight simulation uses the flight control actions and current flight state in the simulation along with other simulation information to determine a new simulated flight state for the next timestep of the simulation. This simulated flight state is passed to a flight visualization controller, which uses it and the motion capture data to provide a simulated flight visualization to the simulator display to show to the pilot in the next timestep of the simulation.

The simulated flight state is also given to an actuator controller, which determines actuation commands to send to the actuators 124. The actuator controller calculates, based on the simulated flight state, how to translate and rotate the simulator cabin 130 such that the pilot 140 experiences realistic sensations of flight motion for the aircraft being simulated. This includes vestibular motion sensation and physical sensation (e.g. from the normal force of the chair the pilot is sitting in). Because the location of the center of mass is closer to the pilot 140 than conventional FFSs, the actuator controller can simulate rotation motion with minimal translational motion. For instance, in one embodiment, the actuator controller simulates rotational motion from the simulated flight state by sending commands that only rotate the simulator cabin 130. The motion tracking data collected from the pilot body state may be used to more accurately provide realistic sensations of flight motion, thus providing an improved simulation to the pilot 140.

FIGS. 4-5 are diagrammatic illustrations of the dimensions and ratios of aspects of a flight simulation platform 110, in accordance with an embodiment of the present disclosure. In this example, the platform 110 may have the exemplary parameter ratios implied by the exemplary parameters in Table 1:

TABLE 1

| Base Diameter | Between 5.4 and 6.0 | |
|---|---|---|
| | meters | |
| Platform Diameter | Between 3.9 to 4.3 meters | |
| Base Leg Separation | 0.35 | meters |
| Platform Leg Separation | 0.35 | meters |
| Platform Diameter-Base Diameter Ratio | 0.72 | |
| Base Leg Separation-Base Diameter Ratio | 0.05 | |
| Platform Leg Separation-Platform Diameter Ratio | 0.05 | |
| Stroke Minimum Length | Between 2.26 and 2.46 | |
| | meters | |
| Stroke Maximum Length | Between 3.76 and 3.79 | |
| | meters | |
| Stroke Actuation Length | 1.5 | meters |
| Bounding Box Length | 6.5 | meters |
| Bounding Box Depth | 6.5 | meters |
| Bounding Box Height | Between 4 and 4.4 meters | |
| Cabin Height | 2.3 | meters |
| Cabin Diameter | 3.8 | meters |
| Anchor Point Reference Displacement | 0.45 | meters |
| Maximum Actuator Velocity | 1 | meters/second |
| Maximum Actuator Force | 50000 | Newtons |
| Minimum Cabin Distance to Ground | 0.25 | meters |

| | |
|---|---|
| Cabin Weight | Between 1500 and 2000 |
| | kilograms |

The parameters listed in Table 1 can be understood with reference to FIGS. 4-5, which provide annotations of many of these parameters relative to the platform 110, as described in FIGS. 2A-2B, the overlapping description of which is omitted for brevity. In further detail, the base 122 diameter is the diameter of the circle formed by the points along the base 122 that the actuators 124 are mounted to. The platform diameter is the diameter of the circle formed by the points along the cabin 130 that the actuators 124 are mounted to. The base leg separation and platform leg separation are the separation between the multiple DOF joints 126 (FIGS. 2A-2B) close to each other along the base 122 and cabin 130, respectively. The bounding box in length, depth, and height are the maximum limits of motion that the simulator cabin 130 will move in each of those directions, whereby no component of the simulator cabin 130 will extend beyond these dimensions when the simulator cabin 130 is placed at its maximum limits of safe, collision free motion. The stroke minimum and maximum lengths specify the minimum and maximum lengths of the actuators 124. To this end, the stroke actuation length is the maximum length an actuator 124 can move a multiple DOF joint. In the embodiment depicted, it is the difference between the minimum and maximum lengths. The maximum actuator velocity specifies the maximum velocity an actuator 124 will move the multiple DOF joint it is connected to. The maximum actuator force specifies the maximum force the actuator 124 will exert on the multiple DOF joint and the simulator cabin 130, which limits the acceleration it exerts.

The cabin height determines the maximum height of the simulator cabin 130. The cabin diameter determines the largest diameter the simulator cabin 130 has in the length-depth plane. The anchor point reference displacement is the offset along the height axis of the length-depth plane formed by the points where actuators 124 are attached to the simulator cabin 130 from the physical center point of the cabin 130.

The maximum actuator force is a part of the determination for the minimum cabin distance to the ground, e.g., the lowest the bottom of the cabin 130 is to the ground plane, and the weight of the cabin.

In another embodiment, the ratios of the platform may be implied by the exemplary dimensions fall in between the ranges listed in Table 2:

TABLE 2

| | |
|---|---|
| Base Diameter | Between 5.4 and 6.0 meters |
| Platform Diameter - Base Diameter ratio | Between 0.65 and 0.78 |
| Platform Diameter | Between 3.8 and 4.2 meters |
| Platform Leg separation | Between 0.15 and 0.4 meters |
| Base Leg Separation | Between 0.2 and 0.7 meters |
| Cabin Height | Between 2.2 and 2.4 meters |
| Anchor Point Reference Displacement | Between 0.5 and 0.8 meters |
| from cabin base level) | |
| Minimum Cabin Distance from Ground | Less than 0.5 meters |
| Bounding Box Length | Between 6 and 6.5 meters |
| Bounding Box Depth | Between 6 and 6.5 meters |
| Bounding Box Height | Between 4 and 4.4 meters |
| Actuator Speed for 40°/s angular velocity | More than 0.8 m/s |
| target (roll, pitch) | |
| Actuator Speed for 20°/s angular velocity | More than 0.4 m/s |
| target (roll, pitch) | |
| Cabin Weight | Between 1500 and 2000 kilograms |

In another embodiment, the ratios of the platform may be implied by the exemplary dimensions in Table 3:

TABLE 3

| Base Diameter | 6.06 | meters |
|---|---|---|
| Platform Diameter | 4.96 | meters |
| Base Leg Separation | 1.0 | meters |
| Platform Leg Separation | 0.31 | meters |
| Platform Diameter-Base Diameter Ratio | 0.82 | |
| Base Leg Separation-Base Diameter Ratio | 0.17 | |
| Platform Leg Separation-Platform Diameter Ratio | 0.0625 | |
| Stroke Minimum Length | 2.67 | meters |
| Stroke Maximum Length | 4.19 | meters |
| Stroke Actuation Length | 1.52 | meters |
| Bounding Box Length | 7.5 | meters |
| Bounding Box Depth | 8.5 | meters |
| Bounding Box Height | 5 | meters |
| Cabin Height | 2.5 | meters |
| Cabin Diameter | 4.3 | meters |
| Anchor Point Reference Displacement | 0.15 | meters |
| Maximum Actuator Velocity | 1 | meter/second |
| Maximum Actuator Force | 32000 | Newtons |
| Minimum Cabin Distance to Ground | 0.25 | meters |
| Maximum Cabin Weight | 3000 | kg |

In another embodiment, the ratios of the platform may be implied by the exemplary dimensions that fall in between the ranges listed in Table 4:

TABLE 4

| | |
|---|---|
| Base Diameter | Between 6.0 and 6.1 |
| | meters |
| Platform Diameter | Between 4.9 and 5.1 |
| | meters |
| Base Leg Separation | Between 0.9 and 1.1 |
| | meters |
| Platform Leg Separation | Between 0.28 and 0.33 |
| | meters |
| Platform Diameter-Base Diameter Ratio | Between 0.8 and 0.84 |
| Base Leg Separation-Base Diameter Ratio | Between 0.15 and 0.19 |
| Platform Leg Separation-Platform Diameter Ratio | Between 1/32 and 1/8 |
| Stroke Minimum Length | Between 2.6 and 2.8 |
| | meters |
| Stroke Maximum Length | Between 4.17 and 4.21 |
| | meters |
| Stroke Actuation Length | Between 1.5 and 1.54 |
| | meters |
| Bounding Box Length | Between 7 and 8 meters |
| Bounding Box Depth | Between 8 and 9 meters |
| Bounding Box Height | Between 4.8 and 5.2 |
| | meters |
| Cabin Height | Between 2.3 and 2.7 |
| | meters |
| Cabin Diameter | Between 4.1 and 4.5 |
| | meters |
| Anchor Point Reference Displacement | Between 0.1 and 0.2 |
| | meters |
| Maximum Actuator Velocity | Between 0.9 and 1.1 |
| | meters/second |
| Maximum Actuator Force | Between 30000 and 34000 |
| | Newtons |
| Minimum Cabin Distance to Ground | Between 0.15 and 0.3 |
| | meters |
| Maximum Cabin Weight | Between 2500 to 3500kg |

In another embodiment, the ratios of the platform may be implied by the exemplary dimensions that fall in between the ranges listed in Table 5:

TABLE 5

| | |
|---|---|
| Base Diameter | Between 5.8 and 6.3 |
| | meters |
| Platform Diameter | Between 4.75 and 5.25 |
| | meters |
| Base Leg Separation | Between 0.75 and 1.25 |
| | meters |
| Platform Leg Separation | Between 0.2 and 0.4 |
| | meters |
| Platform Diameter-Base Diameter Ratio | Between 0.7 and 0.9 |
| Base Leg Separation-Base Diameter Ratio | Between 0.1 and 0.25 |
| Platform Leg Separation-Platform Diameter Ratio | Between 1/64 and 1/4 |
| Stroke Minimum Length | Between 2.5 and 3.0 |
| | meters |
| Stroke Maximum Length | Between 4.1 and 4.25 |
| | meters |
| Stroke Actuation Length | Between 1.4 and 1.6 |
| | meters |
| Bounding Box Length | Between 6 and 9 meters |
| Bounding Box Depth | Between 7 and 10 meters |
| Bounding Box Height | Between 4.6 and 5.4 |
| | meters |
| Cabin Height | Between 2.1 and 2.9 |
| | meters |
| Cabin Diameter | Between 3.9 and 4.6 |
| | meters |
| Anchor Point Reference Displacement | Between 0.05 and 0.25 |
| | meters |
| Maximum Actuator Velocity | Between 0.8 and 1.5 |
| | meters/second |
| Maximum Actuator Force | Between 25000 and 40000 |
| | Newtons |
| Minimum Cabin Distance to Ground | Between 0.1 and 0.4 |
| | meters |
| Maximum Cabin Weight | Between 2000 to 4500kg |

The platform 110 may have many other dimensions and ratios, all of which are considered within the scope of the present disclosure.

The design of the platform 110 may be based on the desired performance of the simulator, and any relevant constraints, and thus may vary depending on the particular design. Accordingly, a platform 110 with various sizes can be used, where the platform 110 has the same ratios between parameters as identified in Table 1 or Table 2. All such platform 110 designs are considered within the scope of the present disclosure. Additionally, it is also possible for a platform 110 to have a design which is based on some or all of the ratios between parameters beyond those specified in Table 1 or Table 2.

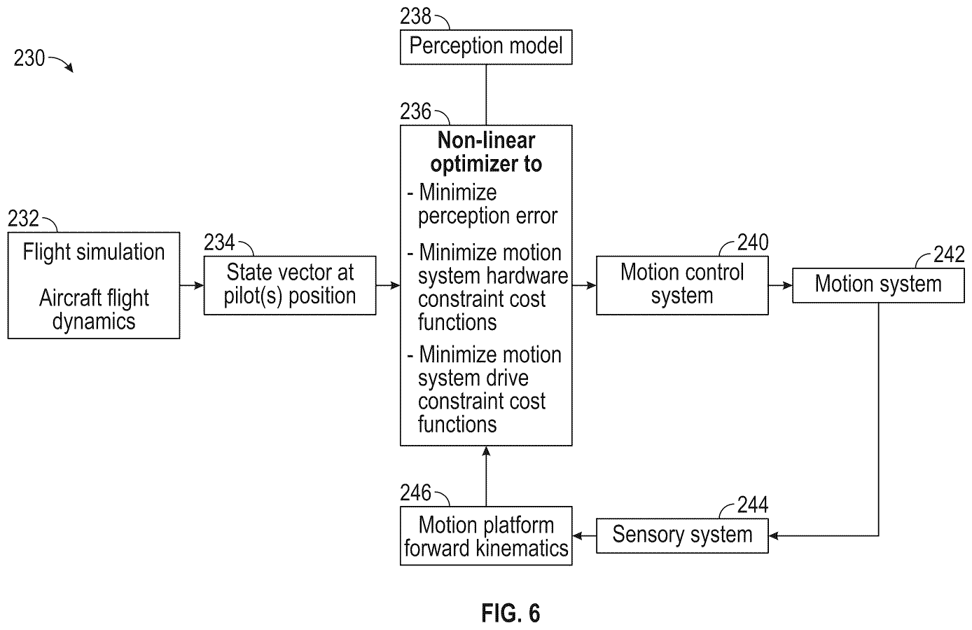

FIG. 6 is a diagrammatic illustration of a simulation and control loop 230 which may be used in the flight simulation system 210 described relative to FIG. 3. As shown at block 232, the flight simulation simulates aircraft flight dynamics to get a state vector for the pilot at the pilot's position, depicted at block 234. At block 236, a nonlinear optimizer, using a perception model of how the pilot perceives movements (block 238), optimizes motions of the simulator cabin to minimize perception error, minimize violation of motion system hardware constraints, and minimize violation of motions system drive constraints. The output of the nonlinear optimizer is fed to a motion control system at block 240 that translates the optimized or desired motions into direct commands for the actuators that form the motion system, at block 242. The motion system then feeds information to a sensory system, at block 244, that detects the actual motions of the simulator cabin and sends data to a motion platform forward kinematics system that updates the nonlinear optimizer on the state of the simulator cabin, as depicted at block 246.

The platform 110, and system 210 which uses the platform 110, may be optimized to achieve the desired simulation. This may include using a design optimization process that optimizes the design ratios for the simulator, including the cabin 130, base 122, and actuators 124 (FIGS. 2A-2B). In one example, a motion platform with a geometric parametrization may be defined by the parameter set p, where an objective function is formulated to ensure that a set of pose states—for instance, position, velocity, and acceleration—can be achieved within specified operational limits. Each state must meet design criteria while adhering to constraints associated with stroke, force, velocity, acceleration, and power of the actuators and other components. These constraint terms represent penalties associated with deviations from the allowable ranges for each of these parameters, respectively.

In one example, the constraint terms used by the design optimization process may include:

$$f ( p ) = \{ \begin{matrix}Minimize : & \begin{matrix}- {V}_{wspc} ( p ) + {\sum }_{{x}_{i} ∈ X} ( {λ}_{1} {d}_{stroke} ( {x}_{i} , p ) + \\ {d}_{force} ( {x}_{i} , p ) + {d}_{\dot{s}} ( {x}_{i} , p ) + {d}_{\ddot{s}} ( {x}_{i} , p ) + \\ {d}_{pwr} ( {x}_{i} , p ) ) )\end{matrix} \\ & \begin{matrix}- {λ}_{2} {\sum }_{{x}_{i} ∈ X} {d}_{leg - cabin} ( {x}_{i} , p ) - {λ}_{3} \\ {\sum }_{{x}_{i} ∈ X} {d}_{cabin - bbox} ( {x}_{i} , p )\end{matrix} \\ Where : & \begin{matrix}{d}_{stroke} ( {x}_{i} , p ) = ‖ max ( 0 , \vert s ( {x}_{i} , p ) - {s}_{min} \vert , \\ {\vert s ( {x}_{i} , p ) - {s}_{max} \vert ) ‖}_{2}\end{matrix} \\ & \begin{matrix}{d}_{force} ( {x}_{i} , p ) = ‖ max ( 0 , \vert f ( {x}_{i} , p ) - {f}_{min} \vert , \\ {\vert f ( {x}_{i} , p ) - {f}_{max} \vert ) ‖}_{2}\end{matrix} \\ & \begin{matrix}{d}_{\dot{s}} ( {x}_{i} , p ) = ‖ max ( 0 , \vert \dot{s} ( {x}_{i} , p ) - {\dot{s}}_{min} \vert , \\ {\vert \dot{s} ( {x}_{i} , p ) - {\dot{s}}_{max} \vert ) ‖}_{2}\end{matrix} \\ & \begin{matrix}{d}_{\ddot{s}} ( {x}_{i} , p ) = ‖ max ( 0 , \vert \ddot{s} ( {x}_{i} , p ) - {\ddot{s}}_{min} \vert , \\ {\vert \ddot{s} ( {x}_{i} , p ) - {\ddot{s}}_{max} \vert ) ‖}_{2}\end{matrix} \\ & \begin{matrix}{d}_{pwr} ( {x}_{i} , p ) = ‖ max ( 0 , \vert {p}_{pwr} ( {x}_{i} , p ) - {p}_{pwr , min} \vert , \\ {\vert {p}_{pwr} ( {x}_{i} , p ) - {p}_{pwr , max} \vert ) ‖}_{2}\end{matrix} \\ & \begin{matrix}{d}_{leg - cabin} ( {x}_{i} , p ) = {min}_{legs} dist ( leg , cabin ( {x}_{i} , p ) ) \\ ( maximize the minimum leg - to - cabin distance )\end{matrix} \\ & \begin{matrix}{d}_{cabin - bbox} ( {x}_{i} , p ) = min dist ( cabin ( {x}_{i} , p ) , bbox ) \\ ( maximize the minimum cabin - to - bounding \\ box distance )\end{matrix}\end{matrix}$$

And where:
V_{wspc}(p): Workspace volume to be maximized.
λ₁: Weight for operational constraint penalties at each pose state xᵢ.
λ₂: Weight for maximizing the minimum leg-to-cabin distance.
λ₃: Weight for maximizing the minimum cabin-to-bounding box distance.
dₛₜᵣₒₖₑ: (xᵢ, p): Penalty for actuator stroke, using bounds sₘᵢₙ and sₘₐₓ.
d_{force}(xᵢ, p): Penalty for force, using bounds fₘᵢₙ and fₘₐₓ.
d_{\dot{s}}(xᵢ, p): Penalty for actuator velocity, using bounds \dot{s}ₘᵢₙ and \dot{s}ₘₐₓ.
d_{\ddot{s}}(xᵢ, p): Penalty for actuator acceleration, using bounds \ddot{s}ₘᵢₙ and \ddot{s}ₘₐₓ.
d_{pwr}(xᵢ, p): Penalty for power, using bounds p_{pwr,min} and p_{pwr, max}.
d_{leg-cabin}(xᵢ, p): Penalty for minimum distance between legs and cabin at each pose state xᵢ.
d_{cabin-bbox}(xᵢ, p): Penalty for minimum distance between cabin and bounding box at each pose state xᵢ.

The objective function may be structured to maximize the safe motion envelope of the cabin 130 (alternatively, minimize the workspace volume defined by the bounding boxes specified relative to FIG. 5 that is not accessible due to the geometric configuration of the simulator), balanced against a weighted sum of constraint penalties. This setup effectively prioritizes the platform's performance within feasible operational limits while discouraging any pose configurations that exceed these bounds.

Additionally, two further objectives may be incorporated to maximize the minimum distance between critical components of the motion platform, aiming to avoid collisions. These objectives are:
1. Leg-to-Cabin Collision Avoidance: This objective maximizes the minimum distance between each leg and the cabin hull mesh. By doing so, the function ensures there is no intersection between the legs and the cabin, preventing collisions during operation.
2. Cabin-to-Bounding Box Collision Avoidance: This objective maximizes the minimum distance between the cabin mesh and the outer bounding box. Ensuring a minimum distance between the cabin and bounding box avoids potential wall collisions.

To achieve the design goals of optimal motion cueing fidelity, a set of pose states may be defined to closely represent critical flight conditions and pilot entry and exit states, represented as a pose state x in the above equations. This approach allows the platform's geometry to be optimized for realistic and accurate motion cues that align closely with in-flight dynamics. Conventional FFSs typically feature a center of rotation and center of gravity positioned significantly above the platform, which often results in constraint violations between joints and with the simulator cabin that reduce the effective motion envelope, defined as the maximum range of motion that a pilot can move during simulation. Alignment of the platform's center of mass more closely with that of a real aircraft minimizes constraint violations and greatly expands the effective motion envelope of the simulator.

It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

### LIST OF REFERENCES

10 conventional full flight simulator (FFS)
20 motion platform
22 base
24 actuators
26 cabin
28 platform
110 flight simulation platform
120 motion platform
122 base
124 actuators
126 multiple DOF joints
128 multiple DOF joints
130 cabin
132 side of cabin
140 pilot
150 horizonal line
210 flight simulation system
220 simulation computer
230 simulation and control loop

What is claimed is:

1. A flight simulation platform comprising:
a base;
a simulator cabin positioned above the base; and
a plurality of actuators connected between the base and a side of the simulator cabin, wherein the plurality of actuators are connected to the side of the simulator cabin in a location substantially corresponding to a center of mass of the simulator cabin.

2. The flight simulation platform of claim 1, wherein the plurality of actuators have retracted and extended states, wherein in a retracted state, the simulator cabin is positioned proximate to a floor on which the base is positioned.

3. The flight simulation platform of claim 1, wherein the location substantially corresponding to the center of mass of the simulator cabin is aligned with a horizontal line positioned through a vertical midpoint of the simulator cabin.

4. The flight simulation platform of claim 1, wherein the location substantially corresponding to the center of mass of the simulator cabin is aligned with a horizontal line positioned below a vertical midpoint of the simulator cabin.

5. The flight simulation platform of claim 1, wherein the location where the plurality of actuators are connected to the side of the simulator cabin is adjustable.

6. The flight simulation platform of claim 1, wherein the plurality of actuators are connected to at least one of the side of the simulator cabin or the base with at least one multiple degree of freedom (DOF) joint.

7. The flight simulation platform of claim 6, wherein the at least one multiple DOF joint translates and rotates the simulator cabin upon actuator motion.

8. The flight simulation platform of claim 1, wherein a center of motion of the simulator cabin is positioned substantially at a vertical midpoint and a horizontal midpoint of the simulator cabin.

9. A flight simulation system comprising:
a flight simulation platform having:
a simulator cabin; and
a plurality of actuators connected to a side of the simulator cabin, wherein the plurality of actuators are connected to the side of the simulator cabin in a location substantially corresponding to a center of mass of the simulator cabin; and
a simulation computer receiving flight control signals from the simulator cabin and outputting a simulated flight state to an actuation controller, wherein the actuation controller controls movement of the plurality of actuators.

10. The flight simulation system of claim 9, wherein the plurality of actuators have retracted and extended states, wherein in a retracted state, the simulator cabin is positioned proximate to a floor on which the base is positioned.

11. The flight simulation system of claim 9, wherein the location substantially corresponding to the center of mass of the simulator cabin is aligned with a horizontal line positioned through or below a vertical midpoint of the simulator cabin.

12. The flight simulation system of claim 9, wherein the location where the plurality of actuators are connected to the side of the simulator cabin is adjustable.

13. The flight simulation system of claim 9, wherein the plurality of actuators are connected to at least one of the side of the simulator cabin or the base with at least one multiple degree of freedom (DOF) joint.

14. The flight simulation system of claim 13, wherein the at least one multiple DOF joint translates and rotates the simulator cabin upon actuator motion.

15. The flight simulation system of claim 9, wherein the flight simulator platform is operatable in a space not exceeding 6 meters in length and width, respectively, and 4.2 meters in height.

16. The flight simulation system of claim 9, wherein the flight simulator platform is operatable in a space having height dimension not exceeding length and width dimensions.

17. The flight simulation system of claim 9, wherein the actuation controller controls movement of the plurality of actuators to simulate rotational motion from the simulated flight state by sending commands that only rotate the simulator cabin.

18. A method of controlling a flight simulation system, the method comprising:
providing a flight simulation platform having:
a simulator cabin; and
a plurality of actuators connected to a side of the simulator cabin, wherein the plurality of actuators are connected to the side of the simulator cabin in a location substantially corresponding to a center of mass of the simulator cabin; and
receiving, at a simulation computer, flight control signals from the simulator cabin; and
outputting a simulated flight state to an actuation controller, wherein the actuation controller controls movement of the plurality of actuators.

19. The method of claim 18, wherein movement of the plurality of actuators moves the simulator cabin around a center of motion of the simulator cabin, wherein the center of motion is positioned substantially at a vertical midpoint and a horizontal midpoint of the simulator cabin.

20. The method of claim 18, further comprising:
simulating aircraft flight dynamics to get a state vector for a pilot at the pilot's position;
in a nonlinear optimizer, optimizing motions of the simulator cabin to minimize perception error, minimize violation of motion system hardware constraints, and minimize violation of motions system drive constraints;
translating optimized motions into direct commands for the plurality of actuators;
detecting actual motions of the simulator cabin; and
updating the nonlinear optimizer on a state of the simulator cabin.
